(19) United States
(12) Patent Application Publication
(10) Pub. No.: US 2013/0158839 A1
(43) Pub. Date: Jun. 20, 2013

(54) METHOD FOR OPERATING A MULTI-FUEL INTERNAL COMBUSTION ENGINE BY MEANS OF TWO CONTROL UNITS, AND MULTI-FUEL INTERNAL COMBUSTION ENGINE WHICH OPERATES IN ACCORDANCE WITH THE METHOD ACCORDING TO THE INVENTION

(71) Applicant: Robert Bosch GmbH, Stuttgart (DE)

(72) Inventor: Werner Striegel, Oberriexingen (DE)

(73) Assignee: ROBERT BOSCH GMBH, Stuttgart (DE)

(21) Appl. No.: 13/714,722

(22) Filed: Dec. 14, 2012

(30) Foreign Application Priority Data
Dec. 14, 2011 (DE) 10 2011 088 497.1

(51) Int. Cl. F02D 19/06

(52) U.S. Cl. CPC F02D 19/061
USPC 701/103

(57) ABSTRACT

A method for operating a multi-fuel internal combustion engine in which a plurality of control units are used. The system is easily scalable and adaptable to internal combustion engines with different numbers of cylinders, wherein the number of cylinders is not limited by the control unit structure.

### BACKGROUND OF THE INVENTION

The invention relates to a method for operating a multi-fuel internal combustion engine, that is to say an internal combustion engine that can be operated with different fuels, for example a gaseous fuel and a liquid fuel (diesel fuel).

Diesel engines are designed such that the air/fuel mixture situated in its combustion chambers auto-ignites shortly before top dead center owing to the temperature increase generated in the compression stroke, and thereby outputs work to the crankshaft of the internal combustion engine.

A disadvantage with the use of diesel fuels in said internal combustion engines is inter alia the emissions arising from the use of the fuel. If gaseous fuels such as propane or natural gas are injected into the combustion chamber of the internal combustion engine instead of or as a partial replacement for the diesel fuel, then it is possible to attain not only an increase in power but rather also considerably lower emissions. Furthermore, said gaseous fuels are less expensive, such that an additional positive effect that is attained is a reduction in operating costs.

Said gaseous fuels however have such a high ignition temperature that auto-ignition does not take place at the end of the compression stroke. As a result, shortly before top dead center is reached, a small amount of diesel fuel is injected into the combustion chamber. Said diesel fuel ignites and raises the temperature of the fuel/air mixture in the combustion chamber to such an extent that the gas contained in the fuel/air mixture is also reliably ignited and outputs work to the crankshaft.

The operation of such multi-fuel internal combustion engines thus requires, for each cylinder, an injector for injecting the liquid fuel and a gas valve by means of which the desired amount of gaseous fuel can be injected into the intake tract and/or directly into the combustion chamber.

The injectors and the gas valves must self-evidently be actuated individually in each case via output stages of corresponding control units. As a result, two output stages are required for each cylinder of the internal combustion engine.

Such multi-fuel internal combustion engines are operated preferably in a so-called multi-fuel mode in which a gaseous fuel is used as main fuel, said gaseous fuel being supplemented by a small amount of injected liquid fuel in order to ensure the ignition of the gas/air mixture situated in the combustion chamber.

Said multi-fuel operating mode however cannot be realized at all operating points and under all ambient conditions, such that operation purely with diesel fuel, referred to hereinafter as diesel operation, must always also be possible.

Master-slave concepts for the control of an internal combustion engine with two engine control units have been known for many years. For example, the D2840 type internal combustion engine, which has been on the market since 2003, from MAN AG is operated with a so-called remote control.

EP 1 485 599 B1, or the German translation thereof DE 603 14 735 T2, discloses a multi-fuel internal combustion engine which has two different control units. A first control unit is responsible, during multi-fuel operation, for the injection of the gaseous fuel, and simultaneously also has the function of a “master” control unit for the second “slave” control unit, which controls the injection of the liquid fuel.

To ensure the exchange of data between the multi-fuel control unit and the diesel control unit, a broadband communication connection, preferably a bus connection, is provided between the control units.

Said concept, which is known from the prior art, has numerous disadvantages. For example, it is necessary for two control units to be provided which, in addition to the broadband communication connection, are connected to one another by means of a hard-wired communication connection. Furthermore, the capacity utilization of the control units differs greatly owing to the different tasks that they must perform. As a result, it is necessary to use either different control units or control units of different capacity. Both solutions have economic disadvantages.

Furthermore, said concept is restricted with regard to the number of cylinders of the internal combustion engine. If for example the multi-fuel control unit that is used has eight power output stages for the actuation of the gas valves and the diesel control unit that is used likewise has eight power output stages for the actuation of the injectors, then the concept known from EP 1 485 599 B1 can be used to operate an internal combustion engine with a maximum of eight cylinders.

### SUMMARY OF THE INVENTION

It is the object of the invention to provide a method for operating a multi-fuel internal combustion engine by means of two or more control units, which method overcomes said disadvantages and can be used even in internal combustion engines with a large number of cylinders.

Said object is achieved according to the invention by means of a method for operating a multi-fuel internal combustion engine comprising a first control unit and at least one further control unit, wherein the control units are connected to one another by means of a broadband communication connection, and wherein a bidirectional transmission of data takes place between the control units via the broadband communication connection, in that each control unit controls the operation of the injector and of the gas valve of at least one cylinder of the internal combustion engine.

For linguistic reasons, it will be stated hereinafter that “one or more cylinders of an internal combustion engine are controlled exclusively by one control unit”. This means that the injector belonging to a cylinder and the gas valve belonging to a cylinder are actuated.

Since each cylinder of the internal combustion engine is actuated exclusively by one control unit, a uniform capacity utilization of the control units is ensured over the entire operating duration and regardless of the operating mode (multi-fuel or diesel operation).

This means for example that, in the case of a control unit with eight power output stages, only one control unit is required if the internal combustion engine has a maximum of four cylinders. If the control unit has six power output stages, said one control unit can operate an internal combustion engine with three cylinders.

If, for example, an internal combustion engine has more than four cylinders, then the actuation of the cylinders can be divided between two control units. In the case of an internal combustion engine with six cylinders, the first control unit would actuate the injectors and the gas valves for example of cylinders 1 to 3, and the second control unit would actuate the injectors and gas valves of cylinders 4 to 6. Furthermore, one of the two control units also acts as a master control unit, while the respective other control unit operates as a slave control unit.

As a result of said task sharing, or the assignment of the cylinders to a control unit, uniform capacity utilization of the control units is ensured regardless of the operating mode of the internal combustion engine. In this way, it is possible to use control units of identical construction which can be utilized in the most effective possible manner with regard to their computing capacity. In the case of internal combustion engines with a small number of cylinders, a single control unit is sufficient.

Furthermore, with said concept it is possible also to operate internal combustion engines with numbers of cylinders greater than the number of power output stages provided on the structurally identical control units, without the need to make comprehensive changes in the structure of the control.

Specifically, if for example an internal combustion engine has ten cylinders, then it is possible, for example, to use three structurally identical control units with in each case eight output stages, wherein the master control unit actuates for example the injectors and gas valves of cylinders 9 and 10, while the two other control units actuate the injectors and gas valves of cylinders 1 to 4 and 5 to 8.

Said concept can be expanded as desired, and requires merely that a broadband communication, such as for example a CAN bus or some other data bus, be installed between all of the control units.

The method according to the invention also has the effect of lowering development costs and considerably simplifying the adaptation of the control units or of the software to different internal combustion engines with different numbers of cylinders.

Aside from the communication between the control units entailed by the master-slave structure, further data are also exchanged via the broadband communication connection. For example, the output data of a first group of sensors may be transmitted via signal lines to a first control unit, which transmits said output signals of the first group of sensors to the other control units via the broadband communication connection. Furthermore, it is self-evidently also possible for a second control unit to receive the output signals of a second group of sensors and to transmit said output signals to the respective other control unit via the said broadband communication connection.

It is ensured in this way that, with minimum outlay in terms of sensors, all of the control units have available the required input variables for the actuation of the injectors and of the gas valves and other actuators, and can then correspondingly actuate these.

With regard to the description of a multi-fuel internal combustion engine, reference is made to EP 1 485 599 B1, and the content of said patent is incorporated by reference into the content of the present application.

Further advantages and advantageous refinements of the invention will emerge from the following drawing, the description thereof and the patent claims. All of the features described in the drawing, in the description thereof and in the patent claims may be essential to the invention both individually and also in any desired combination with one another.

### BRIEF DESCRIPTION OF THE DRAWINGS

In the drawing:

FIGS. 1 and 2 show the basic construction of a multi-fuel internal combustion engine such as is known for example from EP 1 485 599 B1;

FIG. 3 shows a first exemplary embodiment of a control unit concept according to the invention with two control units, in the case of a 6-cylinder internal combustion engine;

FIG. 4 shows the configuration of the control unit concept according to the invention in the case of an internal combustion engine with 10 cylinders and a total of three control units, and

FIG. 5 shows the configuration of the control unit concept according to the invention in the case of an internal combustion engine with three cylinders and only one control unit.

### DETAILED DESCRIPTION

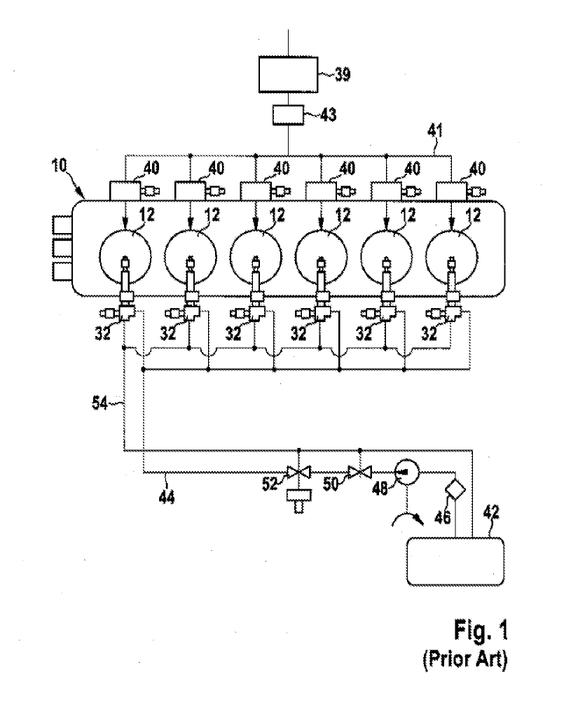

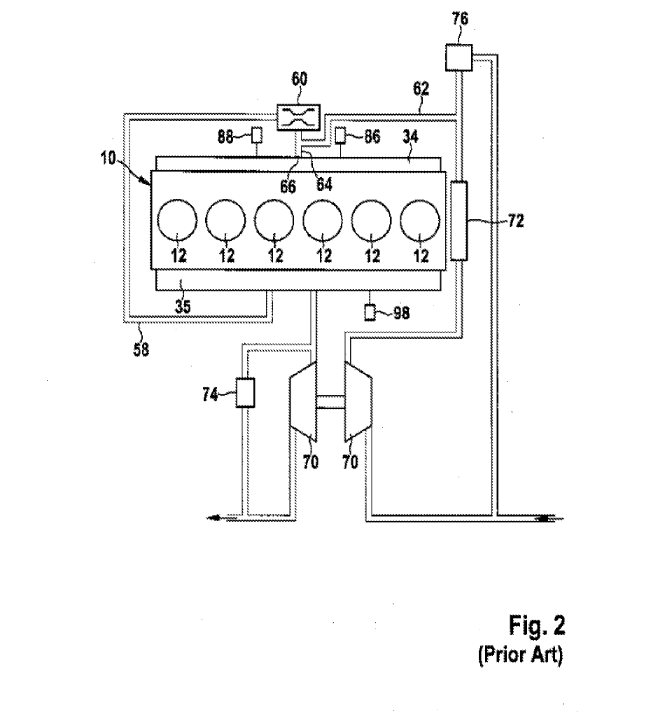

FIGS. 1 and 2 correspond to FIGS. 1 and 2 of EP 1 485 599 B1, to which reference is hereby made. Said figures show the basic construction of a multi-fuel internal combustion engine which has six (6) cylinders and which operates in accordance with the diesel process. Said internal combustion engine can operate both in a pure diesel mode and also in a multi-fuel mode, that is to say with a gaseous fuel as a main energy source and a small amount of diesel fuel as an ignition aid.

FIG. 1 illustrates substantially the fuel supply systems of the multi-fuel internal combustion engine 10. Said multi-fuel internal combustion engine has a total of six cylinders 12 and is designed such that it can ignite the fuel/air mixture situated in the combustion chambers in accordance with the diesel process, that is to say by auto-ignition.

Each cylinder 12 is assigned a piston (without reference numeral). The cylinder bore 12, the piston and a cylinder head (not illustrated in FIGS. 1 and 2) delimit a combustion chamber. The charge exchange of the fuel/air mixture or of the burned fuel/air mixture takes place via conventional gas exchange valves (likewise not illustrated).

The reference numeral 42 denotes a fuel tank for liquid fuel, said fuel tank supplying highly pressurized fuel to the injectors 32 via a fuel line 44. In the fuel line 44 there are arranged a filter 46, a pump 48, a high-pressure release valve 50 and a pressure regulator 52. A return or leakage line 54 conducts the leakage quantities arising at the injectors 32 back into the tank 42.

Said construction is well known to any person skilled in the relevant art in the field of internal combustion engines, and therefore needs no more detailed explanation. In addition to said fuel injection system for liquid fuel (diesel fuel), there is also provided for each cylinder 12 or for each combustion chamber a gas valve 40 to which gaseous fuel is supplied as required from the gas tank 39 via a line 41. To be able to shut off the gas tank 39, a shut-off valve 43 is provided in the gas line 41.

The gas valves 40, like the injectors 32, are in each case briefly opened in order to inject the desired amount of liquid or gaseous fuel either directly into the combustion chambers or into the intake tract of the internal combustion engine 10. Said structural design of an internal combustion engine is known from the prior art.

To illustrate the mode of operation of a multi-fuel internal combustion engine 10 of said type, the passage of the inducted combustion air and of the exhaust gases generated in the combustion chambers is illustrated in FIG. 2.

Starting at the bottom right of FIG. 2, the inducted combustion air enters into an intake line 1, is raised to a higher pressure in a pump impeller of an exhaust-gas turbocharger 70, and is subsequently cooled in a charge-air cooler 72. The internal combustion engine thereafter passes via a line 62 to an intake port 66. An intake manifold is denoted by the reference numeral 34. Said intake manifold distributes the combustion air to the cylinders 12 of the internal combustion engine 10.

The burned fuel-air mixture passes via an intake manifold 35 either into an exhaust-gas recirculation valve 58 and with a flow valve 60, which permits the dosing of the exhaust gases recirculated into the intake tract. The major part of the exhaust gases passes out of the exhaust manifold 35 to the turbine wheel of the exhaust-gas turbocharger 70. From there, said exhaust gas passes via exhaust-gas aftertreatment devices (not illustrated), such as for example catalytic converters and particle filters (both not illustrated), into the environment. The charge pressure is controlled in the conventional way by means of a wastegate valve 74 and/or a bypass valve 76. Said type of guidance of the combustion air and of the exhaust gases is also known from the prior art, and therefore will not be explained in any more detail.

As is already clear when viewing FIG. 1, in the case of a 6-cylinder internal combustion engine, a total of six injectors 32 and six gas valves 40 must be actuated by means of power output stages in the control units (not illustrated).

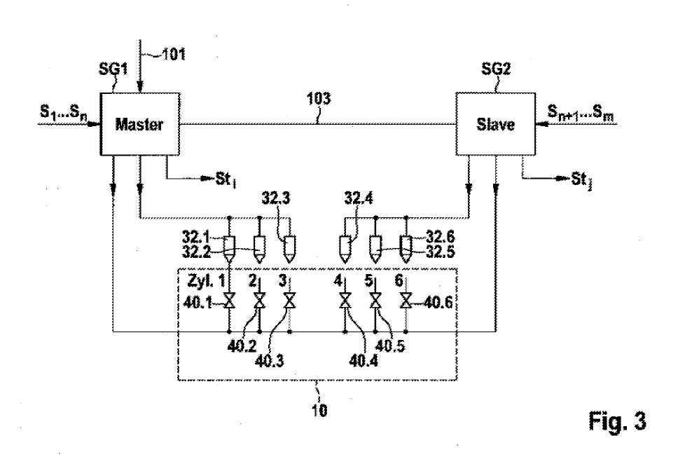

FIG. 3 now shows the control unit concept according to the invention, comprising a first control unit SG1, which serves inter alia also as a master control unit for a second control unit SG2, also referred to as a slave control unit.

The first control unit SG1 receives a multiplicity of input variables S₁ to Sₙ and, in addition to these, the so-called torque demand of the driver, which is ultimately nothing other than the output signal of the accelerator pedal. Said torque demand of the driver is denoted in FIG. 3 by the reference numeral 101. Output variables of the first control unit SG1 are the control commands to the injectors 32.1, 32.2 and 32.3 that are assigned to the cylinders 1, 2 and 3 of the internal combustion engine 10. Three further output variables of the first control unit SG1 are the control commands for the gas valves 40.1, 40.2 and 40.3 of the first three cylinders 1, 2 and 3 of the internal combustion engine 10 when the latter is operating in the multi-fuel mode.

Furthermore, the first control unit SG1 can also generate further output variables, denoted in FIG. 3 by Stᵢ.

The second control unit SG2 is of very similar construction. It has inputs for various sensor signals Sₙ₊₁ to Sₘ and outputs for various control signals, such as for example the control signals 32.4 to 32.6 of the injectors of the cylinders 4, 5 and 6 and for the gas valves 40.4 to 40.6 which supply the cylinders 4, 5 and 6 with the desired amount of gaseous fuel.

Furthermore, there may also be provided further outputs Stj which control further actuators of the internal combustion engine.

Between the first control unit SG1 and SG2 there is provided a broadband communication connection 103, which may be formed preferably as a data bus, such as for example the CAN bus or some other bus system which is conventional in automotive engineering. Via the broadband communication connection 103, not only can the first control unit SG1 perform its function as a master with respect to the second control unit SG2 (slave), but rather it is also possible for the output signals of the sensors S₁ to Sₙ to be transmitted from the first control unit SG1 to the second control unit SG2 and for the output signals of the sensors Sn+1 to Sm to be transmitted from the second control unit SG2 to the first control unit SG1.

As a result, all of the output data of the sensors S1 to Sm is available to the control units SG1 and SG2 simultaneously or with only a minimal delay, such that the control units SG1 and SG2 can actuate the injectors 32.1 to 32.6 and the gas valves 40.1 to 40.6.

In conjunction with the invention, it is important that the first control unit SG1 actuates the injectors 32.1 to 32.2 and the gas valves 40.1 to 40.3 of cylinders 1 to 3, while the second control unit SG2 actuates the injectors 32.4 to 32.6 and the gas valves 40.4 to 40.6 of cylinders 4, 5 and 6. This results in substantially identical functionality of the first control unit SG1 and of the second control unit SG2, and as a result, virtually identical capacity utilization of both control units SG1 and SG2.

The capacity utilization of the control units differs slightly merely because the master control unit must also generate the information/signals for the slave control unit SG2 and transmit said information/signals to the latter. Further differences in capacity utilization may arise in that the first control unit SG1 receives a different number of output signals of sensors than the second control unit SG2. Said differences in capacity utilization are however relatively small and generally permit the use of identical control units or identical hardware for the first control unit SG1 and SG2.

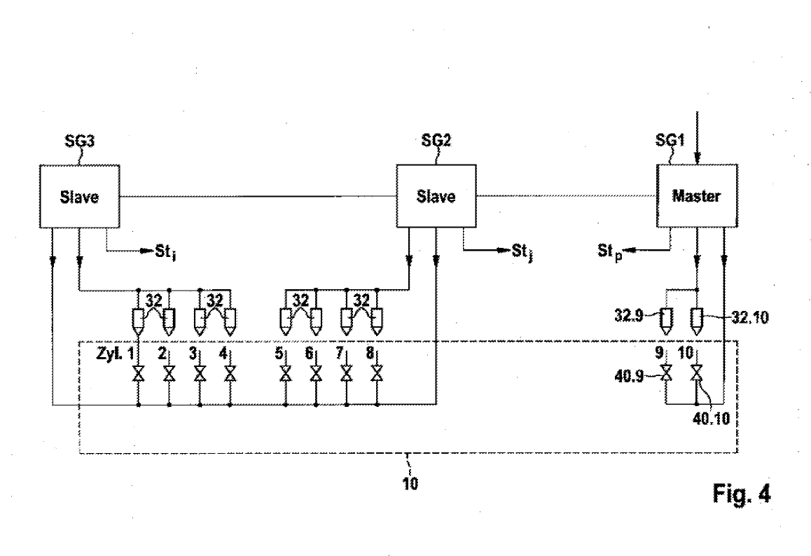

FIG. 4 illustrates a further exemplary embodiment of a control unit architecture according to the invention. It is assumed here, as above, that each control unit SG1, SG2 and SG3 has eight available power output stages, such that one control unit can actuate at most the injectors 32 and the gas valves 40 of four cylinders 12 of the internal combustion engine.

If it is now also assumed that the internal combustion engine 10 has ten cylinders 12, then a total of three control units SG1, SG2 and SG3 can perform the actuation of the total of ten injectors 32 and ten gas valves 40. In this exemplary embodiment, the master control unit SG1 controls the injectors 32.9 and 32.10 of cylinders 9 and 10 and actuates the gas valves 40.9 and 40.10.

The slave control units SG2 and SG3 control in each case four injectors 32 and four gas valves 40 of cylinders 1 to 4 and 5 to 8 respectively. It is clear from this exemplary embodiment how, through the addition of further control units, the actuation of further cylinders 12 can be realized without a great amount of additional outlay with regard to software and application of the control units. The third control unit SG3 must self-evidently also be capable of communicating with the other control units SG2 and SG3 via the broadband communication connection 103.

The further output variables of the control units SG1, SG2 and SG3 are denoted in FIG. 4 by Stₚ, Stⱼ and Stᵢ.

Said control unit concept with three control units may self-evidently also be directly used for the operation of an internal combustion engine 10 with twelve cylinders. If it is sought to operate an internal combustion engine with sixteen cylinders, a fourth control unit SG4 (not illustrated) is connected into the broadband communication connection 103 and the outputs of said fourth control unit SG4 are connected in a corresponding way to the injectors and gas valves of the cylinders 13 to 16.

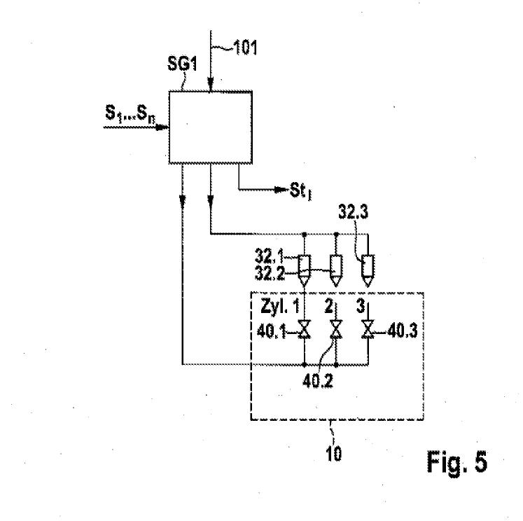

FIG. 5 shows a multi-fuel control unit SG1 according to the invention which has at least six power output stages which serve for the actuation of the injectors 32.1, 32.2 and 32.3 of the gas valves 40.1, 40.2 and 40.3 of cylinders 1, 2 and 3.

Furthermore, the first control unit SG1 can also generate further output variables, denoted in FIG. 3 by St₁.

In the arrangement illustrated in FIG. 5, one control unit SG1 is sufficient to actuate all of the injectors 32.1, 32.2 and 32.3 and gas valves 40.1, 40.2 and 40.3 of the internal combustion engine 10. A second control unit SG2 and a broadband connection 103 can therefore be omitted. In said arrangement, the output signals of all of the sensors S1 . . . Sn are supplied to the single control unit SG1.

1. A method for operating a dual-fuel internal combustion engine (10) comprising a first control unit (SG1) and a further control unit (SG2), wherein the control units (SG1, SG2) are connected to one another of a broadband communication connection (103), and wherein a bidirectional transmission of data takes place between the control units (SG1, SG2) via the broadband communication connection (103), characterized in that each control unit (SG1, SG2) controls the operation of a plurality of injectors (32) and gas valves (40) of at least one cylinder (12) of the internal combustion engine (10).

2. The method according to claim 1, characterized in that more than two control units (SG1, SG2, SG3) are provided.

3. The method according to claim 1, characterized in that the injectors (32) and gas valves (40) of each cylinder of the internal combustion engine (10) are assigned precisely one control unit (SG1, SG2, SG3).

4. The method according to claim 1, characterized in that each control unit (SG1, SG2, SG3) controls the injection of one or two fuels of at least one cylinder (12) of the internal combustion engine (10).

5. The method according to claim 1, characterized in that the control units (SG1, SG2, SG3) are active throughout the entire operating duration of the internal combustion engine (10).

6. The method according to claim 1, characterized in that one control unit (SG1) performs the function of a “master” and the other control units (SG2, SG3) perform the function of a “slave”.

7. The method according to claim 6, characterized in that, in the case of an internal combustion engine (10) with six (6) cylinders, the “master” control unit (SG1) controls the injectors (32) and gas valves (40) of three cylinders (1, 2, 3) of the internal combustion engine and the “slave” control unit (SG2) which controls the injectors (32) and gas valves (40) of the three remaining cylinders (4, 5, 6).

8. The method according to claim 6, characterized in that, in the case of an internal combustion engine (10) with eight (8) cylinders, the “master” control unit (SG1) controls the injectors (32) and gas valves (40) of four cylinders (1, 2, 3, 4) of the internal combustion engine and the “slave” control unit (SG2) which controls the injectors (32) and gas valves (40) of the four remaining cylinders (5, 6, 7, 8).

9. The method according to claim 6, characterized in that, in the case of an internal combustion engine (10) with ten cylinders (12), the “master” control unit (SG1) controls two cylinders (9, 10) of the internal combustion engine and two “slave” control units (SG2, SG3), and in that the two “slave” control units (SG2, SG3) control in each case four cylinders (1, 2, 3, 4, 5, 6, 7, 8).

10. The method according to claim 1, characterized in that the control units (SG1, SG2, SG3) exchange, via the broadband communication (103), data (S1 . . . Sn, Sn+1 . . . Sm) that are present in a control unit (SG1, SG2, SG3).

11. A non-transitory computer readable medium including a program, for use in a method according to claim 1.

12. An electric storage medium for a control and/or regulating unit (SG1, SG2, SG3) of an internal combustion engine (10), characterized in that a computer program for use in a method of claim 1 is stored on said electric storage medium.

13. A multi-fuel control unit (SG1, SG2, SG3) for an internal combustion engine (10), having a plurality of power output stages, characterized in that one part of the power output stages actuates injectors (32) and another part of the power output stages actuates gas valves (40).

14. The multi-fuel control unit (SG1, SG2, SG3) according to claim 13, characterized in that the multi-fuel control unit (SG1, SG2, SG3) has a broadband communication connection (103) for the exchange of data.

15. The multi-fuel internal combustion engine comprising a first control unit (SG1) and optionally one or more further control units (SG2, SG3), characterized in that the one or more control units (SG1, SG2, SG3) are multi-fuel control units (SG1, SG2, SG3) according to claim 13.

16. The multi-fuel internal combustion engine according to claim 15, characterized in that it comprises a first control unit (SG1) and at least one further control unit (SG2, SG3), in that the control units (SG1, SG2, SG3) are connected to one another by means of a broadband communication connection (103), and wherein a bidirectional transmission of data takes place between the control units (SG1, SG2, SG3) via the broadband communication connection (103), and in that the control units (SG1, SG2, SG3) operate a plurality of injectors (32) and gas valves (40) of at least one cylinder (12) of the internal combustion engine (10).

17. The method according to claim 6, characterized in that, in the case of an internal combustion engine (10) with twelve cylinders (12), the “master” control unit (SG1) controls four cylinders (9, 10) of the internal combustion engine and two “slave” control units (SG2, SG3), and in that the two “slave” control units (SG2, SG3) control in each case four cylinders (1, 2, 3, 4, 5, 6, 7, 8).
